(19) United States
(12) Patent Application Publication
(10) Pub. No.: US 2021/0058983 A1
(43) Pub. Date: Feb. 25, 2021

(54) BEARER CONFIGURATION FOR NON-TERRESTRIAL NETWORKS

(71) Applicant: IPCom GmbH & Co. KG, Pullach (DE)

(72) Inventors: Andreas Schmidt, Braunschweig (GB); Martin Hans, Bad Salzdetfurth (GB); Maik Bienas, Schoeppenstedt (GB)

(21) Appl. No.: 16/967,196

(22) PCT Filed: Mar. 8, 2019
(86) PCT No.: PCT/EP2019/055864

§ 371 Date: Aug. 4, 2020

(30) Foreign Application Priority Data
Mar. 9, 2018 (EP) 18160964.5

(51) Int. Cl. H04W 76/10; H04W 36/00; H04W 36/08

(52) U.S. Cl. CPC H04W 76/10; H04W 36/00837; H04W 84/06; H04W 36/08; H04W 36/0085

(57) ABSTRACT

The invention provides method of operating a user equipment, UE, device in a satellite-based mobile communications system, the method comprising receiving from a base station communication parameter sets, each parameter set comprising at least one parameter for use by the UE device for receiving data from or transmitting data to a satellite in the communications system, each parameter set being applied for a different stage of a communication with the system; and applying a plurality of communication parameter sets consecutively for communication with a first satellite.

The present invention relates to the establishment of a bearer configuration for a non-terrestrial network such as a satellite communications network.

Satellite communication or telephone systems are well known. An example is the Iridium telephone and data communication system.

Iridium uses low Earth orbit (LEO) satellites with six orbits and 11 satellites per orbit. The satellites have a height of 781 km and an orbital period of about 100 minutes which results in the time between two satellites in the same orbit passing the same point over ground being about nine minutes.

Currently the next generation of mobile communication standards (5G) is being defined by 3GPP. It will define a network architecture for a core network (5GC) and a new radio access network (NR). In addition, access to the 5GC from non-3GPP access networks is provided.

In 2017, a new activity started in 3GPP to include non-terrestrial access networks (NTN) support into NR. A new study was proposed in 3GPP Tdoc RP-171450 in which NTN are defined as networks, or segments of networks, using an airborne or spaceborne vehicle for transmission:
Spaceborne vehicles: Satellites (including low Earth orbiting (LEO) satellites, medium Earth orbiting (MEO) satellites, geostationary earth orbiting (GEO) satellites as well as highly elliptical orbiting (HEO) satellites)
Airborne vehicles: high altitude UAS platforms (HAPs) encompassing unmanned aircraft systems (UAS) including tethered UAS and lighter than air UAS (LTA), heavier than air UAS (HTA), all operating in altitudes typically between 8 and 50 km, quasi-stationary.

The declared aim is an incorporation of NTN support into the NR. Thus, it is not proposed to allow known satellite communication technologies like Iridium to access the 5GC. It is proposed to include necessary enhancements into the currently developed NR standard to enable operation over the non-terrestrial vehicles described above.

This aim opens a wide range of innovation necessary to allow efficient communication between a UE and a NTN base station or an NTN transceiver.

The most likely deployment model for NTN NR base stations or transceivers are quasi-stationary HAPs and LEO satellites (LEOs). This invention enhances the incorporation of LEOs and MEOs into NR.

A deployment model may be that LEOs are operated by a satellite operator who offers its NTN access to mobile network operators (MNOs) as a shared radio network access, as defined by 3GPP since 3G. The shared NTN RAN would complement the MNO's terrestrial RAN. Each satellite may contribute to the shared RAN in its current coverage area so that a shared RAN used by a specific MNO is offered by multiple satellites dynamically changing as the satellites follow their path through the orbit.

For NTN deployments in general, two architectural alternatives exist:

either the satellite constitutes a base station with all the typical base station intelligence. In this deployment, the base station is connected to a ground station via satellite link, the ground station connecting the satellite to the respective core network;

or the satellite basically constitutes a repeater who routes data between UE and a ground station which is the actual base station. This deployment is often called “bent pipe” deployment.

For the current invention, we use the model with a satellite comprising the base station if not otherwise mentioned. This is only to ease readability and should not cause any loss of generality. The ideas of this invention are valid for the bent pipe deployment as well.

From current NR standardization activities, a flexible parameterization is known for the physical layer, i.e. on a single carrier at the same time multiple transmission time interval (TTI) lengths or different subcarrier spacing values may be used, potentially even by a single UE. However, an automatic transition between physical layer parameters based on expected link changes is not known or foreseen.

The following two patent documents assume deployment of fixed base stations mounted on the ground, therefore they rely on the fact that the link is almost identical if the UE is at the same position, which is an invalid assumption if LEO satellites are used for data transmissions. Therefore, they do not describe a solution for the issues assumed for this invention. Nevertheless, they may be considered relevant.

US 2014/0105046 A1 proposes to determine a plurality of link qualities for a UE at different positions and to store the information. A future link quality at a future position is estimated based on the stored link qualities at stored positions. Resources are allocated to a link based on the estimated future link quality. A transmission mode is selected for a link based on the estimated future link quality.

Link estimation is provided for as well as resource allocation or transmission mode selection based on past positions and link qualities. There is no disclosure or suggestion of methods to use knowledge about fixed and periodic changes of link characteristics to configure multiple resources or transmission modes (wording of the patent) to be used in future depending on an estimation of a current stage of a periodic movement. Especially, the patent does not disclose methods to utilize estimated future positions of base stations from knowledge about periodic base station movement to configure resources or transmission modes.

US 2013/0053054 A1 proposes a method that includes observing at least one of present, prior, or anticipated future movement of a user. Based on the observed user movement, one or more future locations of the user are predicted. Based on the one or more future locations of the user, a communication setting of a device is selected to be used by the user. Especially the selection of a channel based on the prediction is proposed, where the channel may be defined by radio access technology and/or frequency band.

Channel selection or communication setting may be based on UE location prediction which is based on past UE movements. There is no disclosure or suggestion of methods to use knowledge about fixed and periodic changes of link characteristics to configure multiple channels or communication settings (wording of the patent) to be used in future depending on an estimation of a current stage of a periodic movement. Especially, there is no disclosure of methods to utilize estimated future positions of base stations from knowledge about periodic base station movement to configure communication settings or select a channel.

The present invention provides a method of operating a user equipment, UE, device in a satellite-based mobile communications system, the method comprising receiving from a base station communication parameter sets, each parameter set comprising at least one parameter for use by the UE device for receiving data from or transmitting data to a satellite in the communications system, each parameter set being applied for a different stage of a communication with the system; and applying a plurality of communication parameter sets consecutively for communication with a first satellite.

The present invention also provides a mobile communications system comprising a plurality of satellites, wherein a system entity is arranged to store a plurality of communication parameter sets, each communication parameter set comprising at least one parameter for use by the system for communicating via a satellite with a user equipment, UE, device for receiving data from or transmitting data to the UE device, each parameter set being applied for a different stage of a communication with the UE device; and wherein the system entity is further arranged to apply the communication parameter sets consecutively for communication with the UE device.

The present invention provides means to efficiently use radio resources for satellite NR connections making specific use of knowledge about a satellite orbit and satellite movement on the orbit. The predictable future changes of a link between UE and an NTN base station in a satellite are used to configure and use radio bearers (or links or connections, in the following used as synonyms) in an innovative way according to the aspects described below. The predictable future changes are caused by the satellite following its known path along the orbit. The knowledge about further satellites in neighbouring orbits or satellites appearing at the horizon and being potential handover targets is efficiently exploited.

This is unlike to terrestrial radio access network in which changes to a link are normally based on unforeseen events (slow or fast fading, weather, shadowing, . . . ) and periodic measurements and event driven measurement reporting allow a base station to react with e.g. adaption of the configuration or change of transmit power.

This is also unlike to predicting future link characteristics at future UE positions from past link characteristics at past UE positions as the assumption of this invention is a steady and periodic base station movement and multiple configurations are provided to a UE to be used during one or more of the predicted link change periods.

In contrast, the current invention allows pro-active configuration and preparation of changes based on expected changes of the link. The measures proposed by this invention especially provide enhancements to the new 5G NR interface as far as currently known.

One aspect of the present invention is a configuration of a bearer or link of a UE by a base station that comprises multiple configuration parameter sets, the parameter sets to be applied by the UE at different times.

A parameter set consists of one or more parameters each to be used by the UE to receive data from or transmit data to a satellite, the one or more parameters defining at least one feature of the transmission or reception. In the context of the present invention, said feature may for example be a sub carrier spacing, transmit power, a modulation, a coding scheme, a data rate.

The multiple parameter sets are configured by the base station to be deployed by the UE at different stages of a UE-to-satellite link.

The transition between the different parameter sets may be performed in the UE autonomously based on a configured time or a measurement related to the UE-to-satellite link.

Alternatively, the transition may be performed based on a trigger set by the base station. The base station may for example indicate the parameter set or parameters from the set used in a downlink (DL) transmission. Based on reception of a transmission indicating a change from one DL parameter set to another, the UE may start to use a respective uplink (UL) parameter set different from the one used before.

In yet another alternative, the UE may provide measurement reports comprising measurements related to the UE-to-satellite link from which the base station derives the necessity to change the parameter set used for UL and/or DL and indicate the parameter set to the UE.

The UE may be configured to change the used UL parameter set autonomously and determine the point in time for a transition such that with high likelihood no transition back is required for a longer time. This may allow a UE to use in a transmission to a satellite a first UL parameter set basically without indicating the used parameters, as the first set was already confirmed by the base station at connection setup. The UE may then determine based on a configured time or based on measurements of the link a point in time for transition to a second UL parameter set and to indicate usage of the second UL parameter set. The usage starts only after the base station acknowledges the indication. Thereafter the second UL parameter set is used by the UE for a longer time. This may be combined with the receiver of the UE expecting usage of a first DL parameter set until the UE indicates the transition to a second UL parameter set to the base station which causes the UE receiver to accept an indication by the base station of usage of a second DL parameter set which is firstly the acknowledgement of the UL indication and secondly this triggers the UE receiver to expect usage of the second DL parameter set further on.

This is advantageous due to the nature of the satellite link slowly increasing in quality until the satellite has reached its highest point in relation to the ground-based UE and then slowly decreasing.

A similar alternative may be performed by the base station: The base station may change the used DL parameter set autonomously and determine the point in time for a transition such that with high likelihood no transition back is required for a longer time. This may allow a base station to use in a transmission to a UE a first DL parameter set basically without indicating the used parameters. The base station may then determine based on time or based on measurements of the link a point in time for transition to a second DL parameter set and to indicate usage of the second DL parameter set only until the UE acknowledges the indication. Thereafter the second DL parameter set is used by the base station for a longer time without indicating the used parameters. This may be combined with the receiver of the base station expecting usage of a first UL parameter set until the base station indicates the transition to a second DL parameter set to the UE which causes the base station receiver to accept an indication by the UE of usage of a second UL parameter set which is firstly the acknowledgement of the DL indication and secondly this triggers the base station receiver to expect usage of the second UL parameter set further on.

Alternatively, as indicated above, UE and base station may transition from a first parameter set to a second parameter set autonomously without informing each other based on an exact timing. This is advantageous due to the satellite position along its orbit being exactly known by the base station and no additional signaling is required.

The general benefits of using such method to change the transmit parameters are:
a bearer reconfiguration is not necessary for expected changes of the communication link; and
the bearer is adapted to the expected link changes so that it offers optimal transmission and reception settings for corresponding link characteristics.

In another aspect of this invention, one or more base stations and/or a UE may learn conditions for the transition between parameter sets from different satellite crossings. From the transition between parameter sets during a first satellite serving a UE while crossing the UE's position and the impact on the UE-to-satellite link, a better transition instance or better conditions for a transition is derived for subsequent satellites serving the UE while subsequently crossing the UE's position.

This is possible due to the satellites in an orbit moving on basically the exact same path and the UE mobility being negligible compared to the satellite movement so that conditions during a satellite crossing the UE is basically the same for every crossing. However, the conditions are not the same for all UEs or all positions as for example the following environmental conditions influence the UE-to-satellite link:
mountains, hills, buildings or humans shadowing the UE or satellite, respectively,
weather conditions, clouds, fog, smog, air pollution,
outside/line-of-sight vs. in-house position of the UE

The aspect provides counter means allowing a UE or base stations to learn the best point in time or the best thresholds for conditions based on measurements to transition between parameter sets.

In case the satellites each are base stations, the learning may comprise exchange of information between satellites regarding the transmission optimization, e.g. on direct satellite-to-satellite links (also termed Inter-Satellite Links, ISLs in short). In case the base station is based on the ground it may simply optimize stored transition parameters. Alternatively, optimizations or parameters which allow derivation of optimization means are learned by the UE and provided to a target base station after each handover.

The general benefits of using such method to learn transition conditions are:
the transition conditions will be optimized automatically and will therefore lead to an optimized overall system throughput; and
a base station can configure a UE with general settings for a first satellite flyover period, e.g. with conservative settings, and adapt the settings during flyover periods, e.g. to use settings that reach higher quality or efficiency.

In a still further aspect of the invention in the event of a handover of a UE-to-satellite connection from a source satellite to a target satellite, the UE is configured during the handover such that the configured parameter sets are continuously used and the target satellites indicates new conditions for transition between the parameter sets. The new conditions may comprise a timing that is adapted to the relative path of the satellite crossing the UE's position.

The following aspects are usable in combination with any of the above aspects as they relate to the parameters that may be changed while implementing the invention. The parameter set may comprise parameters for modulation, coding, transmit power, radio resources to be used, e.g. frequency bands to be used for UL and/or DL, TTI length, timing for transmission of feedback, number of HARQ processes etc.

Fast adaption of modulation and coding scheme (MCS) is well known from prior art. In contrast, this invention proposes to define multiple sets of potential modulation and coding schemes so that during stages of a flat angle between UE and satellite a first set of MCSs is used and an index of one MCS of the first set is indicated to a receiver while in stages of steeper angle another set of MCSs is used and an indicated MCS index points to an MCS of the second set. A simplified example of the proposed mechanism may be to use a specific higher order modulation, e.g. 64-QAM, only in stages of steep UE-to-satellite angle.

The change of TTI length is especially advantageous as the transmission delay may vary by a factor of 3 during a LEO satellite crossing a UE, e.g. between 2.5 ms and 7.5 ms. For longer transmission delay, a longer TTI and stronger coding may be used to keep the user data per packet at a nearly constant level.

Alternatively, for longer transmission delay, a higher number of HARQ processes may be used to allow for more packets to be transmitted before successful acknowledgement by the receiver. In usual communication systems, the physical layer HARQ processes use fixed time relation between packet reception and transmission of related feedback packets. With higher transmission latency, i.e. for flat UE-to-satellite angles, it is proposed to advance the time relation and in order not to stall the transmission, more HARQ processes of a typical stop-and-wait HARQ mechanism are used. As a result, multiple HARQ feedback cycle lengths and number of HARQ processes are used by the UE and the BS to adapt the HARQ process to the varying transmit delay and the mechanisms mentioned above are used for transition between the parameters.

A change of frequency, so called inter-frequency handover, is well known from prior-art. Shorter and faster frequency shifts (=frequency hopping) are known within a frequency band used by a UE by changing the carrier within the band quickly. Both mechanisms are used to cope with frequency selective fading, different resource demands by the UE or resource availability by the network or simply in case of a handover to a base station with different capabilities. This invention proposes to use two or more frequency bands predictively in the way described above. Lower frequency bands may be configured for longer UE-to-satellite distance while higher frequencies may be used for shorter distance.

In a yet further aspect of this invention, the point in time in which data that needs to be transmitted by a UE to a satellite is synchronized with the expected quality of the UE-to-satellite link, i.e. the data generation and/or data transmission is configured so that it takes place when the link satisfies a quality condition. The time in which data is actually sent may correlate with one or more specific parameter sets from the configured parameter sets for transmission and/or reception being applied so that a transition of the parameter set may trigger transmission or generation or stop of transmission or generation of data.

For example, periodic messages from the UE (in idle mode) to the network, e.g. for re-registration of the UE (Tracking Area Update), are configured to be generated and transmitted by the UE when the satellite has a higher orbit position with regard to the UE position. This may be done by the network or the base station configuring a periodicity for re-registration to the UE that is aligned with the periodicity of serving satellites crossing the UE's position and configuring a time offset for a first re-registration with regard to reception of the configuration message, the time offset ensuring the first re-registration takes place when the satellite has a higher orbit position with regard to the UE position. As alternative solution to configuring a time offset, the UE may perform measurements to find out, when the satellites are in a higher orbit position. The related time offset from this measurement is then also used for the following TAU transmissions. Note that a time offset is currently not configured for periodic TAU message in cellular standards, i.e. periodic re-registration is always sent relative to reception of the configuration messages comprising the periodic TAU timer.

Another example of this aspect is the synchronization of generation of application layer data, e.g. by means of an API informing applications on mobile devices about good timing for delay tolerant data aligned with the satellite orbit. Alternatively, data is marked by an application to be delay tolerant and the UE stores the data until an optimal transmission point is reached.

Another important aspect of this invention is the application of the basic innovative ideas above considering not only the UE-to-satellite link but also the satellite-to-ground-station link. In general, the ground station will be in satellite coverage for a vast portion of the coverage time of the UE. But if the ground station is not really near the UE, the predicted link quality to the ground station may be significantly different form the predicted link quality to the UE. In that case, the conditions or the timing for transition between parameter sets configured to the UE may comprise conditions or timing information that is based on the expected average or worst link quality of the two links. Simply, transitions between the multiple parameter sets are configured so that higher data rate or more robust reception is only used at times where both links are expected to provide such good quality. At times where only the UE-to-satellite link is expected to provide higher data rate or more robust links, for the UE-to-satellite link a parameter set that saves resources may be applied until also the satellite-to-ground-station link is in a higher quality stage.

Preferred embodiments of the invention will now be described, by way of example only, with reference to the accompanying drawings in which

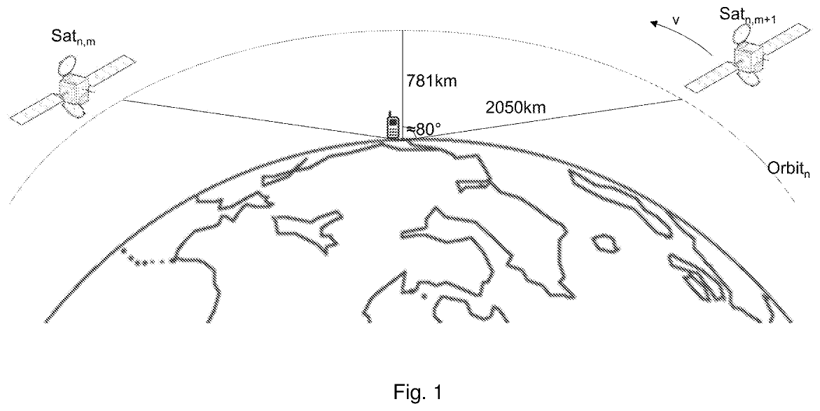

FIG. 1 shows a schematic representation of a communication satellite orbiting the Earth;

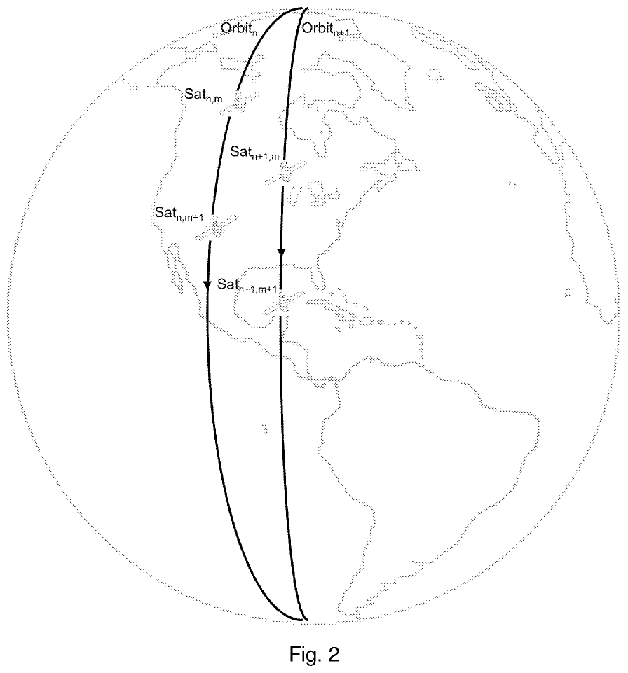

FIG. 2 shows a schematic representation of a plurality of satellites in a communication system;

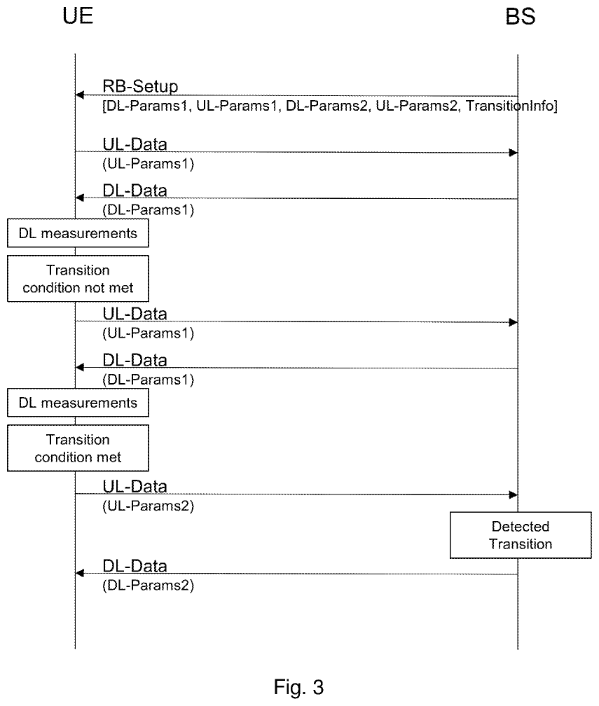

FIG. 3 is a message sequence chart showing message exchanges between a UE and a base station;

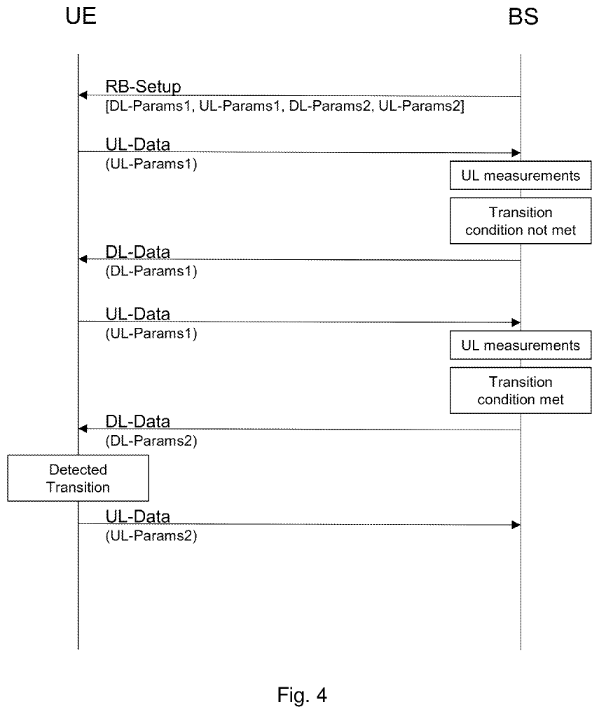

FIG. 4 is a further message sequence chart for a base station initiated transition;

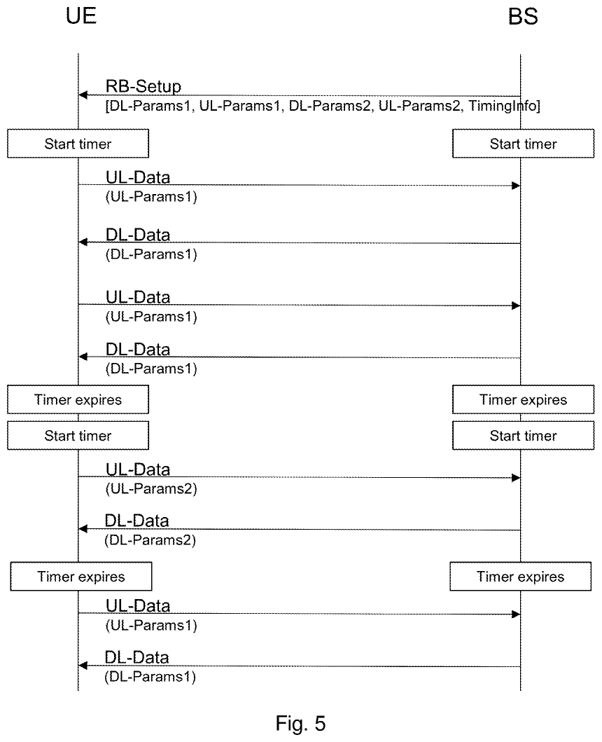

FIG. 5 is a message sequence chart for an autonomous transition;

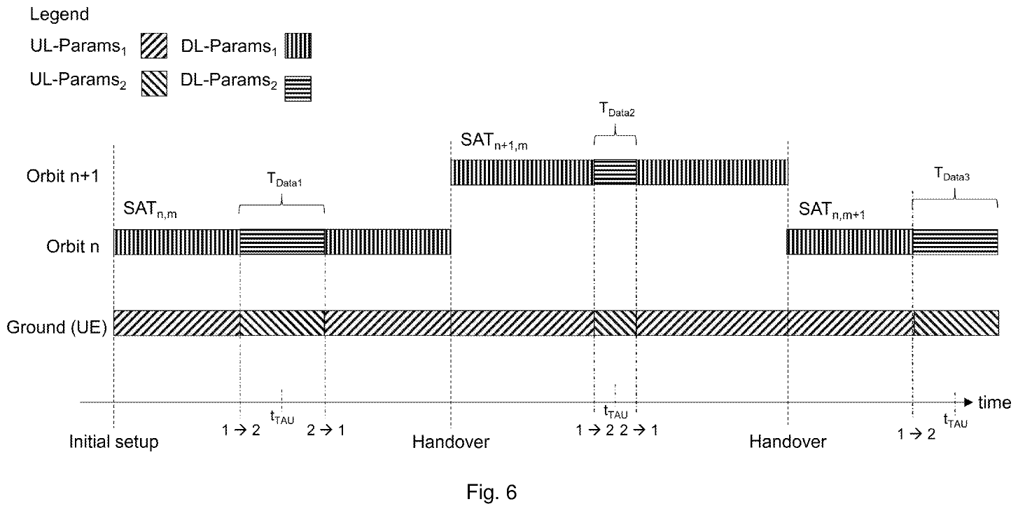

FIG. 6 illustrates a change in communication parameters with time;

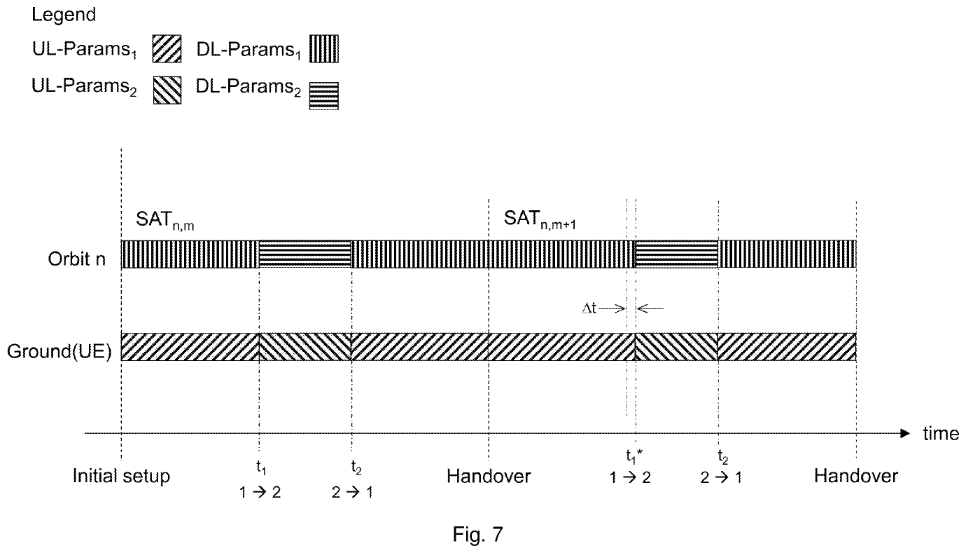

FIG. 7 also illustrates a change in communication parameters with time and

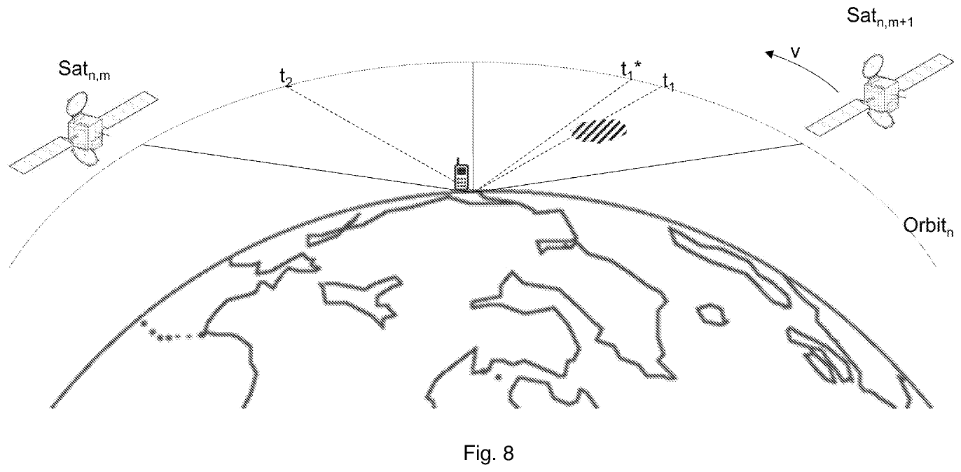

FIG. 8 illustrates how atmospheric conditions may affect transitions.

FIG. 1 shows an example radio access network based on LEO satellites. The figure depicts two satellites (SAT_{n,m} and SAT_{n,m+1}), where the index m iterates the satellites on the same orbit (Orbitₙ). Example wise, two typical distances for LEO satellites are referenced in FIG. 1: the height of the satellites over ground (781 km) and the typical distance of a satellite that becomes visible by a ground based point at typically about 10° over the horizon (2050 km).

In the example setup the time between a satellite appearing at the horizon and the same satellite disappearing on the opposite side is 9 minutes. It becomes clear from FIG. 1 that the link between a ground-based UE and a satellite changes significantly in path loss and latency within these 9 minutes in a basically predictable way.

FIG. 2 shows a similar example setup with two orbits (Orbitₙ and Orbitₙ₊₁), where the index n iterates all the orbits a satellite radio access network may comprise, typically six. On each orbit, only two satellites are shown (index m and m+1, respectively) where typically eleven satellites are present on the full 360°. The nearest satellites on neighboring orbits may be offset by half the satellite distance on one orbit so that UEs that reside on the ground at a point between the orbit planes may be served by satellites of alternating orbits.

The setup of FIGS. 1 and 2 is an example similar to a LEO satellite based system currently deployed. The current invention is as well valid for other setups with different number of satellites, different number of orbits, different inclination of orbits, different height and satellite speed, etc.

FIG. 3 shows a first aspect of this invention in a message sequence chart comprising a UE and a base station. The base station may be (or, deployed in) a satellite or a ground station controlling a transceiver in a satellite. According to this invention, the base station configures a newly setup radio bearer with two distinct sets of transmission (UL) and reception (DL) parameters (Params1 and Params2) and information comprising conditions for transition from one parameter set to another (and potentially back). In the example, these conditions may be based on measurements, e.g. on received signal strength (RSS) of reference signals sent by the base station. This received signal strength, denoted RSS throughout this document, is the measured signal strength of a signal that is not power controlled, i.e. it is a pre-known reference signal transmitted by the base station without modulation or further coding with a fixed or pre-determined transmit power to allow a meaningful measurement on the receive side. It is sometimes referred to as reference signal receive power (RSRP) or similar in literature. Clearly, according to the current invention, the transition conditions correspond to positions of the satellite on its orbit relative to the UE, i.e. an angle under which the satellite is seen and corresponding expected link characteristics. The conditions may comprise one or more measurements and thresholds to be exceeded or undercut that allow the UE to adapt the transmission to the expected link characteristics.

The bearer setup may lead to transmission of data in UL and DL direction by the UE and the base station, respectively. During transmission, the used parameters or parts thereof may be explicitly signaled, e.g. like an index to a modulation and coding scheme (MCS) transmitted in parallel on a control channel as typically done in LTE today. Other parameters may not be signaled and the successful reception relies on the receiver to apply the same parameters as the sender.

The UE may continuously or periodically perform the configured measurements and check for transition conditions to trigger a transition from a first parameter set to a second parameter set already configured.

In the example of FIG. 3 the UE is configured to trigger the parameter transition and inform the base station about the newly applied parameter set, e.g. by transmitting information about the applied UL-parameters. The base station will detect the transition and apply the second DL-parameter set in the downlink, potentially informing the UE.

FIG. 4 shows a similar example as the one described with reference to FIG. 3. The main difference is that the UE is configured with different parameter sets but not with transition conditions. The UE will rely on the base station to determine the point in time for transition to a different parameter set and to inform the UE accordingly. After being informed by DL signaling, the UE will apply the parameter set for UL transmission.

Alternatively, both UE and BS may perform measurements as shown in FIGS. 3 and 4. The receiver in the UE or base station may explicitly request from the transmitter in the base station or UE, respectively, to transit to a different parameter set only for DL or UL, respectively.

The measurements used to determine whether a transition between parameter sets is required or not may comprise RSS as described above. They may also use an angle of arrival of signals received by the UE or the satellite, neighbor satellite measurements, Doppler frequency, i.e. a frequency shift, or speed of RSS degradation or increase.

Yet another alternative is shown in FIG. 5 where the transition condition is purely based on time, therefore the base station configures together with the parameter sets timing information (TimingInfo) to the UE. The timing information gives the exact timing for transitions between parameter sets so that UE and base station can apply parameters based on timers expiring. Clearly, according to the current invention, the timing information corresponds to positions of satellite on its orbit relative to the UE, i.e. an angle under which the satellite is seen and a corresponding link characteristic. The time may be provided in seconds or number of transmission time intervals or a similar unit that allows both UE and base station to switch synchronously.

FIG. 6 describes an example of a UE being served by three satellites on alternating orbits (n and n+1), consecutively. It is assumed that two parameter sets each for UL and DL are sufficient to efficiently exchange data between the UE and a currently serving satellite on both orbits. The figure shows the UL and DL transmit parameters applied in the UE and the satellites with differently shaded bars as depicted in the legend.

At a start time of the figure an initial setup of the UE and the base station takes place in which the two parameter sets for each UL and DL are configured. Transmission starts with UL-Params, and DL-Param₁, which may be optimal for relatively flat angles over horizon and long distances between UE and satellite. At a point in time, UE and base station transit based on measurements to the respective second parameter set which is optimized for shorter distances and a steep angle (“1→2” in FIG. 6). Based on measurements, the transition back may occur. The transition back uses the same measurements, e.g. RSS, or different measurements. The latter may especially be valuable if for flat angles the change in Doppler frequency is significant while for steeper angles, the change of RSS (path loss) may predominate the measurable link characteristics.

In conjunction with the example of FIG. 6, the features described with reference to FIGS. 3 and 4 may be applied, i.e. any one of UE or the base station may trigger the transitions between parameter sets and the transitions in FIG. 6 may take place at different points in time for UL and DL, respectively, triggered separately by both UE and base station.

Further in FIG. 6, as satellite SAT_{n,m} may fade, the UE may be triggered to perform a handover to a second satellite SAT_{n+1,m} on a neighboring second orbit. The same parameter sets may be re-used for the time the new satellite serves the UE, i.e. no reconfiguration of parameters is necessary and the transition conditions may explicitly or implicitly trigger continued usage of the first parameter set after handover. Again, measurement based transitions will occur but they may occur at different times, different also relative to the flyover time of the satellite relative to the UE. The difference may result from the different orbit of the satellite and a resulting difference in the link characteristic over time and/or a different offset between the UE location and the orbit plane of the second satellite in comparison to the first satellite or because weather effects are different for these orbits.

Later in the situation of FIG. 6, another handover to a third satellite SAT_{n,m+1} on the first orbit takes place which may then basically result in transitions at similar relative times as shown for the flyover of the first satellite.

FIG. 7 shows another aspect of the invention. A UE and multiple satellites apply a time-based transition between parameter sets for UL and DL, respectively. The figure shows an example in which the UE is served by a satellite and performs transitions between transmission parameters at times t₁ and t₂ relative to the time when the satellite started to serve the UE or relative to a virtual start time corresponding to a start angle of the satellite to the UE.

FIG. 7 is meant to show the result of the base station learning to optimize the transition time instances t₁ and t₂. In the first flyover, the transition times may have been configured by the base station based on knowledge about the orbit, relative angles between UE and satellite and resulting changes in the link characteristics. However, the example setup may be as depicted in FIG. 8 which similarly to FIG. 1 shows two satellites flying over the UE. At a time period around t₁ the weather conditions between UE and the satellite may be worse than expected, indicated by a bank of fog in FIG. 8. Thus, the transmission between UE and SAT_{n,m} may have suffered from the transition at point t₁ in the first flyover. The base station may adjust and re-configure the configured time instances for transition between parameter sets so that UE and SAT_{n,m+1} will synchronously transit at an adjusted time t₁* at which there is no disturbance between UE and the respective satellites. The transition has thus been adapted by a time Δt in which still the first parameter set is applied to cope with the weather conditions.

Further satellites may continue to use the adjusted timing without a necessary reconfiguration in UE and the respective satellites or base stations.

The learning and adjusting of link configuration between serving base stations or satellites is new as in terrestrial communication systems a periodic or recurring serving circle with predictably changing link characteristics is unknown.

FIG. 6 also shows another aspect of the current invention. To increase efficiency of communication between UE and Satellite periodic data generation in the protocol stack of the UE, e.g. for tracking area updates (TAU) also called re-registration in 5GC, may be synchronized with the predicted link quality. The periodicity of the TAU procedure may be aligned with the periodicity of the satellites serving a UE. In case of a satellite system similar to the one from FIG. 1 the TAU period could be configured by the base station to nine minutes in which case for every flyover of a satellite from a single orbit, there is one TAU procedure performed. An offset is configured to the UE for the first TAU procedure to ensure the procedure is started when the satellite link is expected to be optimal. In FIG. 6, three such time instances are show as t_{TAU}. The periodicity may also be shorter, e.g. half the flyover time, 4.5 minutes, so that a TAU procedure is started for every optimal link condition in case the UE is served by satellites in alternating orbits as depicted in FIG. 2. The period may also be longer, e.g. 18 minutes, to only perform TAU procedures every second flyover.

In another embodiment of this invention, a general optimization for the generation and/or transmission of delay tolerant data may be concentrated on a period of time T_{Data} of better link quality. This period of time may be configured by the base station and it may be identical with the time between two transitions of parameter sets for transmission and reception (e.g., between the transitions “1→2” and “2→1” as shown in FIG. 6). In that case the conditions or the timing configured for parameter transitions may also trigger data generation or transmission of buffered data. FIG. 6 shows example wise three such time intervals T_{DATA1}, T_{DATA2}, and T_{DATA3} that lay between two parameter set transitions. In other deployments, the time period T_{Data} may be shorter or longer than the usage of a specific parameter set. There may alternatively be a defined period, e.g. around the expected handover between two satellites, which is excluded from transmission or generation of delay tolerant data while the remaining time data transmission is possible.

The following are preferred aspects of the invention:

1. A method of operating a user equipment, UE, device in a satellite-based mobile communications system, the method comprising:

receiving from a base station communication parameter sets, each parameter set comprising at least one parameter for use by the UE device for receiving data from or transmitting data to a satellite in the communications system, each parameter set being applied for a different stage of a communication with the system; and

applying a plurality of communication parameter sets consecutively for communication with a first satellite.

2. The method according to aspect 1, wherein the UE device receives transition conditions for transitioning between the communication parameter sets so applied.

3. The method according to aspect 1 or aspect 2, wherein the plurality of communication parameter sets are also applied for communication with a second satellite.

4. The method according to aspect 1 or aspect 3, wherein each communication parameter set is applied for a portion of a satellite orbit.

5. The method according to aspect 4, wherein the portions for which the communication parameter sets are applied for communication with the first satellite correspond substantially with portions for which the communication parameter sets are applied for communication with a second satellite.

6. The method according to any one of aspects 2 to 5, wherein the transition conditions are determined using at least one of measurements performed by the UE device on a communication link with the system and a determination of a stage of an orbit of a satellite with which the UE device is in communication.

7. The method according to any one of aspects 2 to 4, wherein the transition conditions relate to a timing relative to a period of a satellite with which the UE device is in communication.

8. The method according to aspect 3, wherein the first satellite and the second satellite do not share the same orbit.

9. The method according to any preceding aspect, wherein the UE device receives adaptation information, the adaptation information providing information for adapting at least one of the received communication parameter sets.

10. The method according to any preceding aspect wherein the UE device transitions between communication parameter sets autonomously.

11. The method according to any one of aspects 1 to 9, wherein the UE device transitions between communication parameter sets in response to a signal received from the communication system.

12. A mobile communications system comprising a plurality of satellites, wherein a system entity is arranged to store a plurality of communication parameter sets, each communication parameter set comprising at least one parameter for use by the system for communicating via a satellite with a user equipment, UE, device for receiving data from or transmitting data to the UE device, each parameter set being applied for a different stage of a communication with the UE device;

and wherein the system entity is further arranged to apply the communication parameter sets consecutively for communication with the UE device.

13. The system according to aspect 12, wherein a transition between communication parameter sets is performed without informing the UE device of the transition.

14. The system according to aspect 12 or aspect 13 wherein information obtained about transitions between communication parameter sets in respect of a communication between the UE device and a first satellite is used to influence transitions between communication parameter sets for a second satellite communicating with the UE device.

15. The method according to one of aspects 1 to 11 or the system according to one of aspects 12 to 14, wherein the communication parameter set comprises at least one of a sub carrier spacing, a transmit power, a modulation scheme, a coding scheme and a data rate.

16. The method according to one of aspects 1 to 11 or the system according to one of aspects 12 to 14, wherein the stage of the communication is determined by a position of the satellite in its orbit.

1. A method of operating a user equipment, UE, device in a satellite-based mobile communications system, the method comprising:
receiving from a base station
(i) communication parameter sets, each parameter set comprising at least one parameter for use by the UE device for receiving data from or transmitting data to a satellite in the communications system, each parameter set being suitable for being applied for a different stage of a communication with the satellite in the communication system; and
(ii) transition conditions for transitioning between the communication parameter sets; and
applying a first communication parameter set for communication with a first satellite of the communications system and consecutively thereafter applying a second communication parameter set for communication with the first satellite, whereby a transition from applying the first communication parameter set to applying the second communication parameter set is triggered by an evaluation in the UE device of the transition conditions.

2. The method according to claim 1, wherein the plurality of communication parameter sets are also applied for communication with a second satellite.

3. The method according to claim 1, wherein each communication parameter set is applied for a portion of a satellite orbit.

4. The method according to claim 3, wherein the portions for which the communication parameter sets are applied for communication with the first satellite correspond substantially with portions for which the communication parameter sets are applied for communication with a second satellite.

5. The method according to claim 1, wherein the transition conditions are evaluated using at least one of measurements performed by the UE device on a communication link with the system and a determination of a stage of an orbit of a satellite with which the UE device is in communication.

6. The method according to claim 1, wherein the transition conditions relate to a timing relative to a period of a satellite with which the UE device is in communication.

7. The method according to claim 2, wherein the first satellite and the second satellite do not share the same orbit.

8. The method according to claim 1, wherein the UE device receives adaptation information, the adaptation information providing information for adapting at least one of the received communication parameter sets.

9. The method according to claim 1, wherein the UE device transitions between communication parameter sets autonomously.

10. The method according to claim 1, wherein the UE device transitions between communication parameter sets in response to a signal received from the communication system.

11. A mobile communications system comprising a plurality of satellites, wherein a system entity is arranged to store a plurality of communication parameter sets, each communication parameter set comprising at least one parameter for use by the system for communicating via a satellite with a user equipment, UE, device for receiving data from or transmitting data to the UE device, each parameter set being applied for a different stage of a communication with the UE device;
and wherein the system entity is further arranged to apply a first communication parameter set for communication with the UE device and consecutively thereafter to apply a second communication parameter set for communication with the UE device, whereby a transition from applying the first communication parameter set to applying the second communication parameter set is triggered by an evaluation of a transition condition by the system entity.

12. The system according to claim 11, wherein a transition between communication parameter sets is performed without informing the UE device of the transition.

13. The system according to claim 11 wherein information obtained about transitions between communication parameter sets in respect of a communication between the UE device and a first satellite is used to influence transitions between communication parameter sets for a second satellite communicating with the UE device.

14. The method according to claim 1, wherein the communication parameter set comprises at least one of a sub carrier spacing, a transmit power, a modulation scheme, a coding scheme and a data rate.

15. The method according to claim 1, wherein the stage of the communication is determined by a position of the satellite in its orbit.

16. The system according to claim 11, wherein the communication parameter set comprises at least one of a sub carrier spacing, a transmit power, a modulation scheme, a coding scheme and a data rate.

17. The system according to claim 11, wherein the stage of the communication is determined by a position of the satellite in its orbit.
